(19) United States
(12) Patent Application Publication
(10) Pub. No.: US 2008/0288993 A1
(43) Pub. Date: Nov. 20, 2008

(54) Interactive Multi-User Tv Method and System and a Tv Receiver for Using Such a Method

(75) Inventors: Armen Aghasaryan, Savigny-Sur-Orge (FR); Xavier Andrieu, Bretigny Sur Orge (FR); Stephane Betge Brezetz, Paris (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 12/093,802

(22) PCT Filed: Nov. 16, 2006
(86) PCT No.: PCT/FR2006/051184

§ 371 Date: Jun. 2, 2008

(30) Foreign Application Priority Data
Nov. 16, 2005 (EP) 05300933.8

(51) Int. Cl. H04N 7/173

(52) U.S. Cl. 725/106; 725/105

(57) ABSTRACT

The invention relates to an interactive multi-user TV method and system and to a TV receiver for using such a method. The invention method consists of broadcasting a TV program (23) and at least one related interactive program (22) to a TV receiver (3), in downloading the sequences of the related interactive program into terminals (4) connected to a mobile telephony network from said TV receiver device (3) according to a client-server configuration and in performing said interactive program sequences by the terminals (4), each of which exchanges data with the TV receiver (3) via a local communication channel (5). Said invention is particularly suitable for interactive services provided by the same TV receiver to a plurality of users located in proximity thereto.

This invention relates to an interactive multi-user TV method and system. It also relates to a TV receiver and a mobile telephony terminal using such a method. The invention is particularly applicable for interactive services provided by a single TV receiver to a plurality of users located nearby this receiver.

Interactive TV services are used more and more frequently. Complementary resources are downloaded onto TV receivers. Users can simultaneously watch a TV program, for example followed by complementary video, audio, text, image data or other data related to the program, in the background. This complementary information that will subsequently be called interactive information is transmitted with the flow of radio broadcast programs. More particularly, a software program correlated with a TV program is downloaded into TV receivers. For example, interactive software programs are created on service platforms and are then broadcast with the TV programs with which they are related, either simultaneously or not.

Interactive TV program suppliers attempt to propose services with ever increasing performances in terms of interactive exchanges. In particular, this means that the offer of interactive information and possibilities of user reactions, are significantly increased. The offer of interactive multi-user services from a single TV set is within the framework of this expansion of the global offer. This type of interactive service would enable several users grouped around a single TV set to interact with the current program, for example in a family circle. This type of service could advantageously be used for TV games, but also for remote purchases, for example in which users interact from the same TV set.

At the moment, interactive TV service solutions do exist with more or less limited possibilities, particularly for applications involving a plurality of nearby users.

In a first solution, the user dials a special telephone number displayed on the TV screen during a particular program. The dialed telephone number may possibly be replaced by an SMS type message. This type of interaction is not automatic. The user must dial the proposed service numbers manually. Therefore, service offers are limited and not very practical for users.

A second solution uses interactions through classical TV programs or through cable channels. In this case, interactions are made using teletexts or context sensitive menus displayed on TV screens. They form an integral part of services provided by radio or wired networks. This solution is not very suitable for an interactive single set and multi-user service context.

A third solution uses the Internet network, particularly what is called IP-TV channels. These types of services can call upon mobile telephony operators, for example by sending SMS messages through TV screens. Internet accesses enable many interactive service opportunities, also involving mobile telephony operators. However, this solution covers a particular TV transmission technology, namely TV on Internet. It requires a subscription to an Internet network access supplier. Therefore, essentially this solution targets access subscribers to the Internet network and is not sufficiently open to offer services to a broader clientele.

A fourth solution uses radio digital TV and more particularly the DVB-H standard, where DVB is an abbreviation for the term “Digital Video Broadcasting”. The DVB-H standard enables reception terminals to move about freely while receiving TV programs, which is an ideal solution for mobile telephony type terminals. Therefore, this solution is very suitable for TV transmission with a mobile telephone. However, it is expensive to setup, particularly concerning technical interaction means between the TV network and mobile telephony networks, knowing that the DVB-H standard does not use the mobile telephony network at all. It also requires a new broadcasting infrastructure. Finally and especially, this solution does not enable simultaneous interaction of a TV program involving multiple users on a single receiver.

One particular purpose of the invention is to enable the use of a TV service in which a plurality of users interact with a single TV set. To achieve this, the purpose of the invention is an interactive TV method in which a TV program and at least one linked interactive program are broadcast to a TV reception device, parts of the linked interactive program being downloaded in terminals connected to a mobile telephony network from the TV reception device according to a client-server architecture. The TV reception device forms the server station and the terminals form the client stations, a part of the interactive program being run by the operating system of a terminal, a terminal exchanging data with the TV reception device through a communication channel.

Advantageously, the communication channel is a local wireless communication channel. Interactive programs downloaded in the terminals may be run independently of each other. Complementary interactive program data may be downloaded in a terminal as a function of queries setup by this terminal. Complementary interactive program data may also be downloaded in a terminal through the mobile telephony network. Advantageously, the interactive program downloaded into a terminal executes interactions with mobile telephony services, for example these interactions are automatic sending of SMS type messages, automatic dialing of telephone numbers or internet connections through the access provided by the mobile telephony operator.

Interactive program parts may for example be programmed in the Java language in the form of applets.

In one particular embodiment, a functional unit is located in the TV reception device, this functional unit comprising:
a loading module storing the interactive program (22) and transferring interactive program parts to terminals through the communication channel;
a communication module controlling two-directional data flows between the terminals and the TV reception device, the flows passing through the communication channel.

Another purpose of the invention is an interactive TV system for use of the method as described above, comprising:
a TV reception device (3) forming the server station;
at least one terminal (4) connected to a mobile telephony network forming a client station;

the linked interactive program parts being downloaded into a terminal from the TV reception device and executed by the terminal operating system, the terminal being linked to the TV reception device through a communication channel.

Another purpose of the invention is a TV reception device equipped with a functional unit comprising:
a decoding module to extract an interactive program linked to a TV program, from a broadcast flow;
a loading module storing the interactive program and transferring interactive program parts to terminals connected to a mobile telephony network, the program parts being intended to be executed by the terminal;
a communication module controlling the two-directional data flows between a terminal and the functional unit.

Advantageously, the device comprises an interface to communicate with the terminals through a local communication channel. The loading module and the communication module may for example be software modules operating on the operating system of the device. For example, the interactive program parts are programmed in the Java language in the form of applets.

Finally, another purpose of the invention is a mobile telephony terminal comprising at least:
a module for detection of a TV reception device by a wireless communication channel:
an operating system to run at least one interactive software program part downloaded through the communication channel by the TV reception device, the interactive program part being linked to a TV program broadcast on the TV reception device.

For example, the terminal comprises a display module running a program to display information linked to the interactive program part on its screen, and a module running the interactive program part, this module communicating with the local communication channel and with the mobile telephony network.

The main advantages of the invention are that it enables customization of applications, that it perfectly identifies the different players, it is simple to implement and it is economic.

Other characteristics and advantages of the invention will become clear after reading the following description with reference to the appended drawings that represent:

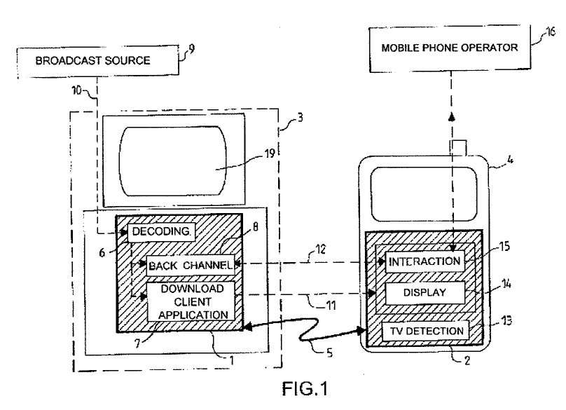

FIG. 1, two functional units for use of the method according to the invention, a first unit being installed on a TV reception device and the second unit being installed on a mobile telephony terminal;

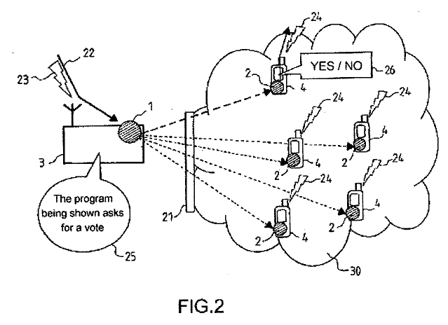

FIG. 2 shows a system according to the invention in operation, during broadcasting of an interactive TV program.

FIG. 1 shows functional units 1, 2 used to implement the invention. A first unit 1 operates in a TV program reception device 3. This first unit 1 may for example be a software module located in the TV receiver 3 or in a box, for example like a decoder, connected to this receiver. Preferably, the TV receiver 3 comprises an operating system also called OS. The operating system runs the programs contained in the first functional unit 1. Therefore the functional unit may be located in the TV receiver like any other application software. If the TV receiver does not have an OS, the functional unit 1 may be located for example in a decoding box connected to the TV receiver. This functional unit 1 will subsequently be called the TV unit. For the remainder of this description, we will use a television receiver TV as an example of a TV program reception device.

The second unit 2 operates on a mobile telephony terminal 4, subsequently called a mobile telephone. The remainder of the description will be made with reference to a mobile telephone, but any type of mobile telephony network terminal can be used. For example, this second functional unit 2 may be a software module located in the mobile telephone 4. It operates with the operating system of the mobile telephone 4. This functional unit 2 will subsequently be called a mobile unit.

The two units 1, 2 communicate with each other through a local wireless communication network 5. For example, this network may be a “bluetooth”, “Wi-Fi”, “UWB”, “Wireless USB”, “Fast IRDA” or even “Zig bee” network. Units 1, 2 comprise the communication interfaces necessary to connect to the local communication network. These local communication means usually exist on existing telephony terminals.

The TV unit 1 comprises a decoding module 6, a loading module 7 of interactive program parts for use on mobile telephones and a communication module 8 with mobile telephones.

The first module 6 decodes interactive information transmitted by a TV program broadcasting source 9. More particularly, during broadcasting of a TV program, the decoding module 6 extracts the interactive program from among other signals in the radiobroadcast flow 10. An interactive program comprises an application and interactive data. This interactive program depends on the TV program. Therefore, the radio broadcast flow includes the TV program and data for the interactive program linked to this TV program. This conventional decoding function may be performed by a module existing in the TV receiver or in an associated decoding box. For example, the interactive information may be of the video, audio or text type. Broadcasting 10 of TV programs and interactive information to the TV receiver may be analogue or digital. It may use radio waves or a cable network.

The loading module 7 stores interactive programs and then transfers program parts to mobile units 2. As will be shown subsequently, it operates like a server in a client-server type application.

The interactive programs are loaded as a function of programs that are running. These interactive programs are extracted by the decoding module 6 and are then stored in the loading module 7. This module then transfers parts of interactive programs to the mobile unit 2 depending on the TV program being shown and user requests. The transfer 11 of interactive data to the mobile unit 2 takes place on the local communication network 5. Advantageously, the interactive program may for example be written in Java and comprises an applet program. Applet stands for “APPLication widgET”. It is a piece of an application written in the Java language. This type of program may be downloaded each time that it is used, in fact when each TV program is transmitted when using the method according to the invention. Advantageously, an applet is portable, in other words it can be run on many systems without having been modified and it does not depend on the system. Therefore, it can be downloaded on mobile telephones independently of the version of their operating system. It is particularly well adapted because most systems installed in mobile telephones are written in Java. Furthermore, the applet can be downloaded almost instantaneously.

The communication module 8 controls two-directional data flows between the mobile unit 2 and the TV unit 1. It receives and processes user requests formulated through the mobile unit 2. It also sends complementary interactive information to the mobile unit 2 as a function of requests sent through this unit 2. The module 8 forms a “back channel” type communication channel, known elsewhere. Exchanges 12 between the communication module 8 and the mobile unit 2 take place through the local communication network 5. Requests processed by the communication module 8 depend on the running program. Specific complementary information requests are processed by this module 8. For example, they may be composed of personal information. Thus for example, during interactive broadcasting of a football match, a user may ask for further information about a specific player.

The loading module 7 and the communication module 8 advantageously use local communication interfaces installed in the TV receiver 3. If there are no such interfaces in this TV receiver, then they have to be installed.

The mobile unit 2 comprises a TV receiver detection module 13, a display module 14 and an interaction module 15.

The main function of the detection module 13 is to detect a TV receiver or an associated box present in the environment of the mobile unit 2. In the example in FIG. 1, the detection module detects the TV receiver 3. The detection method depends on the type of local communication channel 5 used. For example, if a bluetooth or Wi-Fi link is used, the link may be activated conventionally whenever the two units are both on at the same time. In all cases, as soon as the module 13 has detected the TV receiver 3, it sets up a connection with the TV unit 1 through the local communication network 5.

The display module 14 comprises a program to display interactive information on the screen of the mobile telephone 4. To do this, it uses the resources of the mobile telephone 4. Considering the previous example of interactive broadcasting of a football match, complementary information about a player is displayed on the mobile telephone screen. The information is personalized and only the user of this mobile telephone will receive this information. Obviously, the displayed information may be in the form of an interaction menu, this menu depending on the TV program. The interaction menu can also use the resources of the mobile telephone 4.

The interaction module 15 executes the interactive program itself. More specifically, the interactive program is applied on the mobile telephone at the interaction module. These means that the parts of the application program stored in the TV unit 1 are downloaded in this module 15. Advantageously, as described above, these program parts may for example be applets. The applets are downloaded dynamically as a function of the TV program and particularly as a function of requests sent by the mobile unit 2 that translate the user's requests. The interactive program part also acts on display resources of the mobile telephone to control the display of information that appears on the screen.

The module 15 communicates with the communication module 8 of the TV unit 1 to obtain complementary information. It may also use the services of the mobile telephony operator 16 to obtain complementary information in relation to the current TV program. It can thus start sending an SMS or automatically dial a telephone number to communicate with a service related to the TV program. For example, this message may be a vote or a choice made by the mobile telephone user to a question displayed on the screen 19 of the TV receiver. The module 15 can also access available services on the Internet.

FIG. 2 shows interactions between the different elements of a system implementing the method according to the invention. More particularly, FIG. 2 shows a TV receiver on which a TV unit 1 like that described above, and several mobile telephones 4, are installed. Each of these mobile telephones is equipped with the mobile unit 2 like that described above. The mobile telephones are activated in relation with a mobile operator. They are located close to the TV receiver 3 in an area 30 in which the local communication 5 may be activated with this receiver. A TV program 23 is radio broadcast and picked up by the TV receiver 3. A particular interactive software program 22 linked to this TV program is transmitted simultaneously by the radio broadcast flow and is then extracted by the decoding module 6. The interactive program can also be broadcast before or after the TV program is broadcast.

This interactive program 22 is then stored in the loading module 7 at the output from the decoding module 6. This interactive program performs a server type function towards the mobile units 2 acting as client stations. The TV unit 1 at the server end dialogues with the mobile units 2 at the client end through its communication module 8, the system thus operating in a client-server type configuration. In the following, we will consider the interactive program downloaded in the TV unit 3 as an application server and interactive program parts downloaded in mobile units 2 as client applications.

Setting up 21 of the local communication 5 may be triggered after downloading of the interactive program, the server application, in the TV unit 1. The local communication can also be set up before this downloading.

While the TV program 23 is being broadcast, or at any other time, the different client applications will be transferred to the mobile units 2 and executed by them in the mobile telephones 4 with their own resources, and particularly their operating system. As mentioned above, client applications are for example advantageously programmed in the Java language in the form of applets. Client applications are downloaded by the loading module 7. Preferably, the user can decide whether or not to validate this transfer. This possibility of a choice can be processed by the display module 14 of the mobile units 2.

Each client application, once downloaded in a mobile telephone 4, is run independently of the other client applications downloaded in other mobile telephones. During execution of the client application, the mobile unit 2 may be in communication firstly with the TV unit 1 through the local communication channel and then the communication module 8 of the TV unit, and secondly with the mobile telephony network 24, for example to send an SMS type message or to dial a telephone number. More particularly, the operating system of the mobile telephone 4 communicates conventionally with the mobile telephony network to which the user is subscribed and with the application server located in the TV unit 1 at the TV receiver 3.

FIG. 2 shows an example broadcast in which the current program suggests a vote 25. The users or telespectators are expected to reply “yes” or “no” 26. The answer 27 is materialized for example by an SMS or by dialing a specific telephone number. The SMS message is sent or the telephone number is dialed automatically as a function of the answer selected by the user. The selection may be made in different ways, for example by using a set of items displayed on the mobile telephone screens. In all cases, the proposed answers for the vote are selected and automatic replies are sent on the mobile telephony network by the client applications. In the case of the example in FIG. 2 dealing with a vote, a method according to the invention offers many processing possibilities. One first possibility is to propose a vote in which possible answers are displayed on the screen as a function of the subject of the vote. The subject of the vote and possible answers are the same for all telespectators. Answers to votes are made as described above. The result of the vote is displayed on the screen 19 of the TV receiver 3. The result indicated relates to telespectators included in the area 30 but also all other telespectators. The local result may be displayed on the TV screen 3 at the same time, if the answers given by the telespectators present in the area 30 are sent in parallel to the TV unit 3. This local result can then be displayed on the TV screen superposed on the general result. Another possibility is customization of the vote. In this case, the subject of the vote may be displayed on the mobile telephone screen rather than on the TV screen, the answers being sent to the mobile telephony network and/or the TV set 1, thus offering customization as a function of the users.

A method according to the invention increases the performances of many other examples of interactive TV programs. For example, we might consider a remote purchasing program. The articles are presented by the TV program. Each user can request particular clarifications about the proposed articles. To achieve this, the mobile telephone unit of a user sends a specific request to the communication module 8. The complementary information about the article is displayed on the screen of the user's mobile telephone. The user can then order the article through the mobile telephony network. Advantageously, his identity and his bank data are perfectly identified from his personal subscriber account with the operator. The purchase procedure is thus facilitated and is made more reliable.

Another example of an improved interactive program relates to taking bets, particularly for horse racing. In this example, the TV set 3 in FIG. 2 is installed in a café or in a special betting office. A horse racing program is broadcast and users present in the café can use their mobile telephones to place their bets on horses instead of filling in a form. For example, the bets are sent on the mobile telephony network to the organization that organizes the bet, for example the PMU in France. Betters are identified unambiguously by their mobile telephone user accounts.

The above examples illustrate performances available with the method according to the invention. Interactive procedures are automatic in these examples, but they remain under the control of users. Several users can interact simultaneously with a single TV receiver. Finally, the use of a method according to the invention is economic because it uses existing radio broadcasting structures, mobile telephony communication networks and local communication means.

1. Interactive TV method in which a TV program (23) and at least one related interactive program (22) are broadcast to a TV reception device (3), characterized in that parts of the linked interactive program, programmed in the form of applets, are downloaded in terminals (4) connected to a mobile telephony network from the TV reception device (3) according to a client-server architecture, the TV reception device (3) forming the server station and the terminals (4) forming the client stations, a part of the interactive program being run by the operating system of a terminal (4), a terminal exchanging data with the TV reception device (3) through a communication channel (5).

2. Method according to claim 1, characterized in that the communication channel (5) is a local wireless communication channel.

3. Method according to claim 1, characterized in that the interactive programs downloaded in the terminals (4) are run independently of each other.

4. Method according to claim 1, characterized in that complementary interactive program data are downloaded in a terminal (4) as a function of queries setup by this terminal (4).

5. Method according to claim 1, characterized in that complementary interactive program data are downloaded in a terminal (4) through the mobile telephony network.

6. Method according to claim 1, characterized in that the interactive program (4) downloaded into a terminal executes interactions with mobile telephony services.

7. Method according to claim 1, characterized in that the interactive program parts are programmed in the Java language in the form of applets.

8. Method according to claim 1, characterized in that a functional unit (1) is located in the TV reception device (3), this functional unit comprising:
a loading module (7) storing the interactive software program (22) and transferring interactive program parts to terminals (4) through the communication channel (5);
a communication module (8) controlling two-directional data flows between the terminals (4) and the TV reception device (3), the flows passing through the communication channel (5).

9. Interactive TV system in which a television program (23) and at least one related interactive program (22) are broadcast to a TV reception device (3), characterized in that it comprises:
the TV receiver device (3) forming the server station;
at least one terminal (4) connected to a mobile telephony network forming a client station;
parts of the related interactive program, programmed in the form of applets, being downloaded into a terminal (4) from the TV reception device (3) and run by the operating system of the terminal (4), the terminal being related to the TV reception device (3) through a communication channel (5).

10. System according to claim 9, characterized in that the communication channel (5) is a local communication channel.

11. System according to claim 9, characterized in that interactive programs downloaded into terminals (4) are run independently of each other.

12. System according to claim 9, characterized in that complementary interactive program data are downloaded in a terminal (4) as a function of queries setup by this terminal (4).

13. System according to claim 9, characterized in that the interactive program (4) downloaded into a terminal executes interactions with mobile telephony services.

14. System according to claim 9, characterized in that interactive the program parts are programmed in the Java language in the form of applets.

15. System according to claim 9, characterized in that a functional unit (1) is located in the TV reception device (3), this functional unit comprising:
a loading module (7) storing the interactive program (22) and transferring interactive program parts to a terminal (4) through the communication channel (5);
a communication module (8) controlling two-directional data flows between a terminal (4) and the TV reception device (3), the flows passing through the communication channel (5).

16. TV reception device, characterized in that it is equipped with a functional unit (1) comprising:
a decoding module to extract an interactive software program (22) linked to a TV program (23), from a broadcast flow (10);
a loading module (7) storing the interactive program (22) and transferring interactive program parts programmed in the form of applets to terminals (4) connected to a mobile telephony network, the program parts being intended to be executed by the terminals (4);
a communication module (8) controlling the two-directional data flows between a terminal (4) and the functional unit (1).

17. Device according to claim 16, characterized in that it comprises an interface to communicate with a terminal (4) through a local communication channel (5).

18. Device according to claim 16, characterized in that since it has an operating system, the loading module (7) and the communication module (8) are software modules operating on this operating system.

19. Device according to claim 16, characterized in that the interactive program parts are programmed in the Java language in the form of applets.

20. Mobile telephony terminal, characterized in that it comprises at least:
a module (13) for detection of a TV reception device (3) by a wireless communication channel (5);
an operating system to run at least one interactive software program part downloaded through the communication channel (5) by the TV reception device (3), the interactive program part programmed in the form of applets being linked to a TV program broadcast on the TV reception device.

21. Terminal according to claim 20, characterized in that it comprises a display module (14) running a program to display information linked to the interactive program part, on its screen.

22. Terminal according to claim 20, characterized in that it comprises a module (15) running the interactive program part, communicating with the local communication channel (5) and with the mobile telephony network.
